(19) United States
(12) Patent Application Publication
(10) Pub. No.: US 2025/0237181 A1
(43) Pub. Date: Jul. 24, 2025

(54) METHOD FOR REPORTING A CORROSION PROBLEM ON A FUEL INJECTOR NOZZLE OF AN INTERNAL COMBUSTION ENGINE

(71) Applicant: VITESCO TECHNOLOGIES GMBH, Regensburg (DE)

(72) Inventors: Bruno VIALAN, Toulouse (FR); Stéphane ELOY, Toulouse (FR)

(21) Appl. No.: 18/838,518

(22) PCT Filed: Apr. 17, 2023
(86) PCT No.: PCT/EP2023/059866

§ 371 Date: Aug. 14, 2024

(30) Foreign Application Priority Data
Apr. 20, 2022 (FR) FR2203612

(51) Int. Cl. F02D 41/22; F02B 75/18; F02D 41/04; G07C 5/08

(52) U.S. Cl. CPC F02D 41/221; F02B 75/18; F02D 41/04; G07C 5/0808; F02B 2075/1812; F02D 2041/224

(57) ABSTRACT

The invention relates to a method for reporting a corrosion problem on a motor vehicle considered new, said method having the following steps:
a step of monitoring (E0) the operating stability;
a step of determining (E1) a reference corrective factor (KREF) for each cylinder;
a step of storing (E2) the reference corrective factor (KREF) determined for each cylinder;
a step of monitoring (E3) the operation of the engine at said determined operating point (PF);
a step of determining (E4) a new vehicle corrective factor (KNEF) for each cylinder;
a step of computing (E5) the difference (DIF) between the stored reference corrective factor (KREF) and the new vehicle corrective factor (KNEF) for each cylinder;
a reporting step (E6) indicating that the fuel injector tip of the cylinder is corroded.

### TECHNICAL FIELD OF THE INVENTION

The invention relates to a method that aims to report the occurrence of corrosion on a fuel injector tip of a motor vehicle engine, such as a diesel or gasoline internal combustion engine. The method is implemented on a motor vehicle having a mileage of less than 3000 km. Such a motor vehicle is considered new for the purposes of the present invention.

### PRIOR ART

It is known that certain motor vehicles, shortly after being put into service, have fuel injector tips exhibiting corrosion. Specifically, a fuel injector is subjected to high temperatures, which consequently necessitates a surface heat treatment. This surface heat treatment protects the fuel injector against attacks to which it could be subjected. During the first combustions, steam from these combustions may cause corrosion on the fuel injector tip. This corrosion occurs because the surface heat treatment has not had enough time to set in place. This phenomenon is observed during the first few hundred kilometers traveled by motor vehicles. Furthermore, a fuel injector tip has an orifice, or even several orifices, with a very small diameter, machined with great precision and through which the fuel, such as diesel oil or gasoline, passes in order to be subsequently injected into the cylinder of the internal combustion engine of the motor vehicle. In certain cases, the corrosion may cause the diameter of the orifice to increase. This phenomenon is observed in the fuel injectors of new motor vehicles. Beyond 3000 km, the fuel injector corrodes less readily. Consequently, the phenomenon disappears. However, when the phenomenon occurs, in a new motor vehicle, the jet of fuel coming from the fuel injector is no longer optimal, which thus results in the internal combustion engine producing pollution. The driver of the motor vehicle is alerted to this problem by a warning light present on the dashboard.

Currently, when this problem is detected, a trial-and-error approach is taken to try and find the cause associated with the pollution problem. Specifically, the pollution may be caused by, for example, a defective fuel pump or any other element of the internal combustion engine that could cause a pollution problem. The technician in charge of resolving the problem may consider replacing the fuel injectors, but, in this case, they would replace all the fuel injectors since they have no way of confidently determining which fuel injector is defective. Thus, the investigations to resolve the pollution problem may be time-consuming. Furthermore, the defective fuel injector is replaced along with the fuel injectors in full working order. For example, for an internal combustion engine having four cylinders, it is necessary to replace four fuel injectors for each new motor vehicle exhibiting this problem.

The aim of the present invention is therefore to overcome the disadvantages of the prior art by proposing a method that is straightforward to implement and makes it possible to report the occurrence of corrosion on the tip of a fuel injector. The method furthermore makes it possible to confidently indicate the implicated fuel injector.

### DISCLOSURE OF THE INVENTION

To this end, the invention thus relates, in its broadest sense, to a method for reporting a corrosion problem on a fuel injector tip of an internal combustion engine of a motor vehicle considered new or essentially new, said engine having at least three cylinders, said cylinders each comprising a fuel injector, said method having the following steps:
a step of monitoring the operating stability of the engine at a determined operating point, the motor vehicle having a mileage of zero or essentially zero;
a step of determining a reference corrective factor for each cylinder, in order to correct an amount of fuel injected into each cylinder with a view to regulating the engine speed and so as to compensate for the manufacturing spread from cylinder to cylinder, when the engine is running in an essentially stable manner at said determined operating point;
a step of storing the reference corrective factor determined for each cylinder if a variation in the reference corrective factor is lower than a predetermined variation value for a predetermined duration or, if the variation in the reference corrective factor is greater than said predetermined variation value, the determination step is then repeated;
a step of monitoring the operation of the engine at said determined operating point when the vehicle enters a determined interval of distance traveled in which the vehicle may still be classified as new or essentially new and when the engine is running in an essentially stable manner at said determined operating point;
a step of determining a new or essentially new vehicle corrective factor for each cylinder, in order to correct an amount of fuel injected into each cylinder with a view to regulating the engine speed;
a step of computing the difference between the stored reference corrective factor and the new or essentially new vehicle corrective factor for each cylinder if a variation in the new or essentially new vehicle corrective factor is lower than a predetermined variation value for a predetermined duration or, if the variation in the reference corrective factor is greater than said predetermined variation value, the determination step is then repeated;
a reporting step indicating that the fuel injector tip of the cylinder is corroded if the computed difference is greater in terms of absolute value than a predetermined reporting value.

A new, or essentially new, vehicle, for the purposes of the present invention, has a mileage of less than or equal to 3000 km.

Preferably, the step of determining a new or essentially new vehicle corrective factor for regulating the engine speed for each cylinder, in order to correct an amount of fuel injected into each cylinder with a view to regulating the engine speed, is implemented when the motor vehicle has a determined interval of distance traveled of between 600 km and 1000 km.

Preferably, the predetermined variation value is between 1% and 5% of the reference corrective factor or of the new or essentially new vehicle corrective factor.

Preferably, said predetermined reporting value is between 0.01 and 0.03.

Preferably, said determined operating point corresponds to the engine idle speed.

The invention also relates to a computer program comprising instructions that, when the program is executed by a computer, cause the computer to implement the steps of the method according to the invention.

The invention furthermore relates to a computer comprising means capable of implementing the steps of the method according to the invention.

The invention additionally relates to a motor vehicle having a computer according to the invention.

### BRIEF DESCRIPTION OF THE DRAWINGS

One embodiment of the present invention will be described below by way of nonlimiting examples and with reference to the appended figures, in which:

FIG. 1 illustrates the steps, in the form of a flowchart, of a method for reporting the occurrence of corrosion on the tip of a fuel injector according to the invention;

FIG. 2 shows, in graph form, the corrective factors as a function of the fuel mass injected per cycle for a new fuel injector as well as the corrective factors, at various engine speeds, for the same fuel injector, when the tip exhibits corrosion.

### DETAILED DESCRIPTION OF EMBODIMENTS OF THE INVENTION

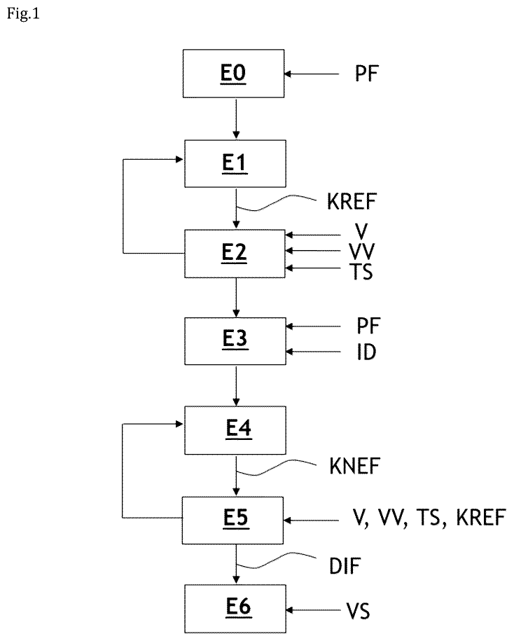

Reference is made to FIG. 1, which illustrates the steps of the method according to the invention in the form of a flowchart. The method aims to report the occurrence of corrosion on a fuel injector tip of an internal combustion engine of a motor vehicle. The method is implemented on a new motor vehicle, namely a vehicle having a mileage of less than 3000 km. The method may, for example, be implemented on an internal combustion engine having four cylinders, each cylinder having a fuel injector. Each fuel injector has a tip in which an orifice is machined with great precision. The first combustions produced by the internal combustion engine produce water and, when a cylinder of the internal combustion engine remains closed while the internal combustion engine is stopped, the water may corrode the fuel injector associated with said cylinder. The corrosion causes the diameter of the orifice for injecting fuel into the cylinder to increase. Consequently, this increase in diameter causes pollution. A warning light warns the driver of the motor vehicle of this pollution problem. The method according to the invention is implemented as soon as possible before the problem arises and in the manner described below.

In an initial step E0, the operating stability of the engine at a determined operating point PF is monitored. The step E0 is implemented as soon as the vehicle is put into service, namely when it has a mileage of zero or essentially zero.

In a first step E1, a reference corrective factor KREF for regulating the engine speed is determined for each cylinder. The step E1 makes it possible to compensate for the manufacturing spread from cylinder to cylinder. It is implemented when the engine is running in an essentially stable manner at the determined operating point PF such as when the engine is idling. In order to determine each reference corrective factor KREF, a reference rotation time TREF required for the crankshaft to perform a rotation of 180° is measured. The rotation time TREF is measured, for example, by means of a gearwheel, also referred to as a target, fixed to the crankshaft and having an angle marker, each passage of which, as the crankshaft rotates, is detected by a position sensor associated with the target of the crankshaft. This produces information, upon each passage, which is converted into an electrical signal represented by ascending and descending edges. The reference rotation time TREF is deduced by means of these ascending and descending edges.

In the case of a perfect internal combustion engine, the reference rotation time TREF obtained for each cylinder is identical, for example 30 ms for a rotational speed of 1000 rpm. In the case of an actual internal combustion engine, the reference rotation time TREF differs between each cylinder on account, in particular, of the machining tolerances of the target of the crankshaft. For example, in the case of an internal combustion engine having four cylinders, for the first cylinder, a rotation time of equal to 29.89 ms is measured, for the second cylinder, a rotation time of equal to 30.11 ms is measured, for the third cylinder, a rotation time of equal to 29.91 ms is measured, and for the fourth cylinder, a rotation time of equal to 30.09 ms is measured. It is consequently observed that there is variability between the rotation times measured. In order to obtain an essentially equal rotation time for each cylinder, a reference corrective factor KREF for injecting fuel for each cylinder is determined so as to obtain a sum of corrective factors equal to N, N being the number of cylinders of the internal combustion engine in question. This obtains an average corrective factor equal to 1. For example, for an internal combustion engine comprising four cylinders, the sum of the corrective factors is equal to 4. For example, the sum may be as follows: 0.9 (for the first cylinder)+1.0 (for the second cylinder)+1.1 (for the third cylinder)+1.0 (for the fourth cylinder). The reference corrective factor KREF makes it possible to standardize the measurement. In the above example, the reference corrective factor KREF brings all the rotation times, in the case of equivalent combustion, to 30 ms for a rotation of the crankshaft of 180°. The amount of fuel introduced into each cylinder is regulated so as to obtain reference rotation times that are equal, to within the reference corrective factor KREF. The amount of fuel introduced into each cylinder thus differs from a reference corrective factor KREF with respect to the amount of fuel that should have been introduced if the regulation had not been applied.

In a second step E2, the reference corrective factor KREF for each cylinder is stored if, for a duration TS, the reference corrective factors KREF are stable. For example, with the reference corrective factor KREF having a variation V, the reference corrective factor is considered to be stable if the variation V is lower than a predetermined variation value of between 1% and 5%. For example, when the motor vehicle is stopped at a traffic light, the duration TS may be equal to 2 minutes. The reference corrective factors KREF are stored if the variation V in the reference corrective factor KREF is between 1% and 5% for the duration TS. Another example relates to the case in which the motor vehicle is traveling at a steady speed such as 50 km/h for a duration TS equal to 1 minute. The reference corrective factors KREF are stored if they remained stable for the duration TS equal to 1 minute. For example, when the motor vehicle is stuck in traffic, the reference corrective factors KREF are not stable because the engine speed and load are constantly changing. In this case, the reference corrective factors KREF are not stored and the determination step E1 is repeated.

In a third step E3, the operation of the engine at said determined operating point is monitored when the vehicle enters a determined interval ID of distance traveled in which the vehicle may still be classified as new or essentially new and when the engine is running in an essentially stable manner at the determined operating point PF. The distance traveled for the determined interval ID may be, for example, between 600 km and 1000 km.

In a fourth step E4, a new or essentially new vehicle corrective factor KNEF is determined for each cylinder by measuring the rotation time TNEF required for the crankshaft to perform a rotation of 180°. The rotation time TNEF is measured in the same manner as the reference rotation time TREF. The step E4 makes it possible to correct an amount of fuel injected into each cylinder with a view to regulating the engine speed.

In a fifth step E5, the difference DIF between the stored reference corrective factor KREF and the new or essentially new vehicle corrective factor KNEF for each cylinder is computed for each cylinder if a variation V in the new or essentially new vehicle corrective factor KNEF is lower than a predetermined variation value VV for a predetermined duration TS or, if the variation V in the reference corrective factor KREF is greater than said predetermined variation value VV, the determination step E4 is then repeated.

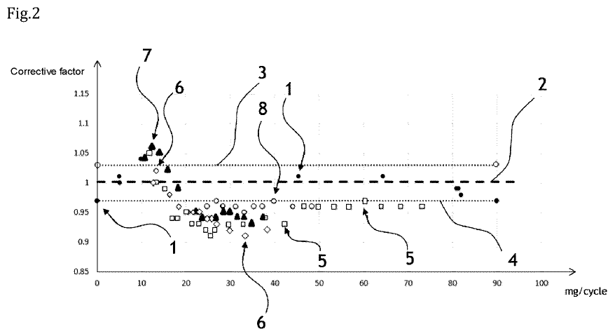

In a sixth step E6, it is indicated that the fuel injector tip is corroded for the cylinder for which said difference is greater in terms of absolute value than a predetermined value VS. For example, reference is made to FIG. 2, which illustrates the reference corrective factor KREF and the new vehicle corrective factor KNEF at various speeds as a function of the fuel mass injected per cycle for a new internal combustion engine. The values for the reference corrective factors for a new fuel injector are represented by a scatter plot 1, illustrated in the form of solid circles. Furthermore, the reference corrective factor 2, equal to 1, is illustrated by a horizontal dashed line. An upper limit for variation in the new vehicle corrective factor 3 is represented by a horizontal dotted line; in this case it is located at 1.03. A lower limit for variation in the new vehicle corrective factor 4 is represented by a horizontal dotted line; in this case it is located at 0.93. When the values of the new vehicle corrective factors KNEF are located outside the lower and upper limits, the fuel injector is considered to be corroded.

A scatter plot 5, illustrated by squares, represents the values of the new vehicle corrective factors for a corroded injector tip at an engine speed of 2040 rpm. At low load, a point of the scatter plot 5 exceeds the upper limit for variation in the new vehicle corrective factor 3; it is located at around 1.05. Still at low load, a portion of the scatter plot 5 is located below the lower limit for variation in the new vehicle corrective factor 4. It is thus reported that the fuel injector tip is corroded.

A scatter plot 6, illustrated by rhombuses, represents the values of the new vehicle corrective factors KREF for a corroded injector tip at an engine speed of 1767 rpm. At low load, a portion of the scatter plot 6 is located below the lower limit for variation in the new vehicle corrective factor 4. It is thus reported that the fuel injector tip is corroded.

A scatter plot 7, illustrated by triangles, represents the values of the new vehicle corrective factors KREF for a corroded injector tip at an engine speed of 1520 rpm. At low load, a portion of the scatter plot 7 exceeds the upper limit for variation in the new vehicle corrective factor 3. Still at low load, a portion of the scatter plot 7 is located below the lower limit for variation in the new vehicle corrective factor 4. It is thus reported that the fuel injector tip is corroded.

A scatter plot 8, illustrated by circles, represents the values of the new vehicle corrective factors for a corroded injector tip at an engine speed of 1270 rpm. A portion of the scatter plot 8 is located below the lower limit for variation in the new vehicle corrective factor 4. It is thus reported that the fuel injector tip is corroded.

In the example illustrated in FIG. 2, the initial step E0 and then the first step E1 of the method according to the invention are implemented in order to determine the reference corrective factor KREF. The second step E2 is subsequently implemented in order to store the reference corrective factor KREF for various load conditions so as to obtain the scatter plot 1, and then the third step E3 is implemented. By subsequently implementing the fourth step E4, the fifth step E5 and the sixth step E6, the difference DIF between the reference corrective factor KREF relating to the scatter plot 1 and the scatter plots 5, 6, 7, 8 is computed. In the example illustrated in FIG. 2, certain points of the scatter plots 5, 6, 7, 8 are located outside the lower and upper limits 3, 4. Consequently, the seventh step E7 is implemented in order to report that the fuel injector tip is corroded for the cylinder in question.

The method according to the invention advantageously makes it possible to confidently report that a fuel injector tip is corroded. It furthermore makes it possible to target the problematic fuel injector. The technician in charge of resolving the pollution problem thereby determines, by virtue of the method according to the invention, the implicated cylinder and, as a result, the fuel injector to be replaced. The method thus makes it possible to save time and to avoid replacing all the fuel injectors of the internal combustion engine as well as other components such as the fuel pump.

The method may be implemented using a computer program executing instructions in accordance with the above-described steps of the method.

Preferably, a computer for a motor vehicle, also known as an ECU (engine control unit), incorporates means for implementing the steps of the method according to the invention.

Preferably, the computer for a motor vehicle is installed in a motor vehicle.

The method according to the invention may be implemented in a diesel or gasoline engine or any other type of internal combustion engine.

1. A method for reporting a corrosion problem on a fuel injector tip of an internal combustion engine of a motor vehicle considered new or essentially new, said engine having at least three cylinders, said cylinders each comprising a fuel injector, said method having the following steps:
a step of monitoring (E0) the operating stability of the engine at a determined operating point (PF), the motor vehicle having a mileage of zero or essentially zero;
a step of determining (E1) a reference corrective factor (KREF) for each cylinder, in order to correct an amount of fuel injected into each cylinder with a view to regulating the engine speed and so as to compensate for the manufacturing spread from cylinder to cylinder, when the engine is running in an essentially stable manner at said determined operating point (PF);
a step of storing (E2) the reference corrective factor (KREF) determined for each cylinder if a variation (V) in the reference corrective factor (KREF) is lower than a predetermined variation value (VV) for a predetermined duration (TS) or, if the variation (V) in the reference corrective factor (KREF) is greater than said predetermined variation value (VV), the determination step (E1) is then repeated;
a step of monitoring (E3) the operation of the engine at said determined operating point (PF) when the vehicle enters a determined interval (ID) of distance traveled in which the vehicle may still be classified as new or essentially new and when the engine is running in an essentially stable manner at said determined operating point (PF);
a step of determining (E4) a new or essentially new vehicle corrective factor (KNEF) for each cylinder, in order to correct an amount of fuel injected into each cylinder with a view to regulating the engine speed;
a step of computing (E5) the difference (DIF) between the stored reference corrective factor (KREF) and the new or essentially new vehicle corrective factor (KNEF) for each cylinder if a variation (V) in the new or essentially new vehicle corrective factor (KNEF) is lower than a predetermined variation value (VV) for a predetermined duration (TS) or, if the variation (V) in the reference corrective factor (KREF) is greater than said predetermined variation value (VV), the determination step (E4) is then repeated;
a reporting step (E6) indicating that the fuel injector tip of the cylinder is corroded if the computed difference (DIF) is greater in terms of absolute value than a predetermined reporting value (VS).

2. The method as claimed in claim 1, characterized in that the step of determining (E4) a new or essentially new vehicle corrective factor (KNEF) for regulating the engine speed for each cylinder, in order to correct an amount of fuel injected into each cylinder with a view to regulating the engine speed, is implemented when the motor vehicle has a determined interval (ID) of distance traveled of between 600 km and 1000 km.

3. The method as claimed in claim 1, characterized in that the predetermined variation value (VV) is between 1% and 5% of the reference corrective factor (KREF) or of the new or essentially new vehicle corrective factor (KNEF).

4. The method as claimed in claim 1, characterized in that said predetermined reporting value (VS) is between 0.01 and 0.03.

5. The method as claimed in claim 1, characterized in that said determined operating point (PF) corresponds to the engine idle speed.

6. A computer program comprising instructions that, when the program is executed by a computer, cause the computer to implement the steps of the method as claimed in claim 1.

7. A computer for a motor vehicle comprising means capable of implementing the method as claimed in claim 1.

8. A motor vehicle having a computer as claimed in claim 7.
